(19) United States
(12) Patent Application Publication
(10) Pub. No.: US 2015/0115815 A1
(43) Pub. Date: Apr. 30, 2015

(54) LIGHT EMITTING DEVICE

(71) Applicant: GREEN POWER RECYCLE CORPORATION, Hsinchu City (TW)

(72) Inventors: Kuo-Hung HUANG, Hsinchu City (TW); Kuei-Hsiang CHIANG, Hsinchu City (TW)

(21) Appl. No.: 14/522,835

(22) Filed: Oct. 24, 2014

(30) Foreign Application Priority Data
Oct. 25, 2013 (CN) 201310511789.2

(51) Int. Cl. H05B 33/08

(52) U.S. Cl. CPC H05B 33/0815
USPC 315/191; 315/200 R

(57) ABSTRACT

A light emitting device includes a rectifier circuit, a mutual inductance device coupled to the rectifier circuit, an energy-storing capacitor coupled to a common node of a primary winding and a secondary winding of the mutual inductance device, a light emitting unit coupled to the mutual inductance device, a switch unit coupled to the light emitting unit, and a control circuit. The control circuit is coupled to the energy-storing capacitor and controls operation of the switch unit according to a voltage across the energy-storing capacitor.

### CROSS-REFERENCE TO RELATED APPLICATION

This application claims priority to Chinese Application No. 201310511789.2, filed on Oct. 25, 2013.

### BACKGROUND OF THE INVENTION

1. Field of the Invention

The invention relates to a light emitting device, and more particularly to a light emitting device that may have a high power factor and a constant voltage/current feedback control mechanism.

2. Description of the Related Art

Conventional light emitting devices may include a light emitting unit and a control circuit for driving the light emitting unit. The control circuit has a power factor that is closely associated with efficiency of a power supply system. A conventional control circuit usually has a power factor correction circuit for promoting the power factor. However, since the conventional control circuits that are capable of correcting the power factor are usually highly complicated, high costs in research and production are usually incurred.

### SUMMARY OF THE INVENTION

Therefore, an object of the present invention is to provide a light emitting device that may have a high power factor and a constant voltage/current feedback control mechanism, and that may have a relatively simple circuit structure, to thereby reduce costs.

According to an aspect of the present invention, a light emitting device is adapted to receive an alternating-current (AC) voltage signal generated by an AC signal source, and comprises:

a rectifier circuit to be electrically coupled to the AC signal source for receiving and rectifying the AC voltage signal, and configured to generate a rectified signal;

a mutual inductance device including:
a primary winding having a first terminal electrically coupled to the rectifier circuit for receiving the rectified signal, and a second terminal; and
a secondary winding having a first terminal electrically coupled to the second terminal of the primary winding, and a second terminal;

an energy-storing capacitor having a first terminal electrically coupled to the second terminal of the primary winding, and a second terminal;

a light emitting module including:
a light emitting unit; and
a resonant capacitor electrically coupled across the light emitting unit;

a resonant inductor in series connection with the light emitting module, the series connection of the resonant inductor and the light emitting module being electrically coupled between the first terminal of the primary winding and the second terminal of the secondary winding;

a switch unit and a feedback unit that are electrically coupled in series, and that are configured to electrically couple the second terminal of the secondary winding to a reference node, wherein the switch unit is disposed to receive a pulse width modulation (PWM) signal, and is configured to make or break electrical connection in response to the PWM signal, the feedback unit being configured to sense one of a voltage and a current associated with a common node of the switch unit and the feedback unit, and to provide a sensed result; and

a control circuit having a power supply terminal electrically coupled to the first terminal of the energy-storing capacitor, a driving terminal electrically coupled to the switch unit, and a sensing terminal electrically coupled to the feedback unit for receiving the sensed result therefrom, the control circuit being configured to generate and provide the PWM signal to the switch unit via the driving terminal thereof, and to adjust a duty cycle of the PWM signal according to a voltage at the power supply terminal.

According to another aspect of the present invention, a light emitting device is adapted to receive an alternating-current (AC) voltage signal generated by an AC signal source, and comprises:

a rectifier circuit to be electrically coupled to the AC signal source for receiving and rectifying the AC voltage signal, and configured to generate a rectified signal;

a mutual inductance device including:
a primary winding having a first terminal electrically coupled to the rectifier circuit for receiving the rectified signal, and a second terminal; and
a secondary winding having a first terminal electrically coupled to the second terminal of the primary winding, and a second terminal;

an energy-storing capacitor having a first terminal electrically coupled to the second terminal of the primary winding, and a second terminal;

a light emitting unit having a first terminal electrically coupled to the second terminal of the secondary winding, and a second terminal;

a rectifying diode having an anode electrically coupled to the second terminal of the light emitting unit, and a cathode electrically coupled to the first terminal of the secondary winding;

a switch unit and a feedback unit that are electrically coupled in series, and that are configured to electrically couple the second terminal of the light emitting unit to a reference node, wherein the switch unit is disposed to receive a pulse width modulation (PWM) signal, and is configured to make or break electrical connection in response to the PWM signal, the feedback unit being configured to sense one of a voltage and a current associated with a common node of the switch unit and the feedback unit, and to provide a sensed result; and

a control circuit having a power supply terminal electrically coupled to the first terminal of the energy-storing capacitor, a driving terminal electrically coupled to the switch unit, and a sensing terminal electrically coupled to the feedback unit for receiving the sensed result therefrom, the control circuit being configured to generate and provide the PWM signal to the switch unit via the driving terminal thereof, and to adjust a duty cycle of the PWM signal according to a voltage at the power supply terminal.

According to yet another aspect of the present invention, a light emitting device is adapted to receive an alternating-current (AC) voltage signal generated by an AC signal source, and comprises:

a rectifier circuit to be electrically coupled to the AC signal source for receiving and rectifying the AC voltage signal, and configured to generate a rectified signal;

a mutual inductance device including:
a primary winding having a first terminal electrically coupled to the rectifier circuit for receiving the rectified signal, and a second terminal; and
a secondary winding having a first terminal electrically coupled to the second terminal of the primary winding, and a second terminal;

an energy-storing capacitor having a first terminal electrically coupled to the second terminal of the primary winding, and a second terminal;

a light emitting module having a first terminal electrically coupled to the second terminal of the secondary winding, and a second terminal, and including an energy-storing inductor and a light emitting unit electrically coupled in series between the first terminal and the second terminal of the light emitting module;

a freewheeling diode having an anode electrically coupled to the second terminal of the light emitting module, and a cathode electrically coupled to the first terminal of the light emitting module;

a switch unit and a feedback unit that are electrically coupled in series, and that are configured to electrically couple the second terminal of the light emitting module to a reference node, wherein the switch unit is disposed to receive a pulse width modulation (PWM) signal, and is configured to make or break electrical connection in response to the PWM signal, the feedback unit being configured to sense one of a voltage and a current associated with a common node of the switch unit and the feedback unit, and to provide a sensed result; and

a control circuit having a power supply terminal electrically coupled to the first terminal of the energy-storing capacitor, a driving terminal electrically coupled to the switch unit, and a sensing terminal electrically coupled to the feedback unit for receiving the sensed result therefrom, the control circuit being configured to generate and provide the PWM signal to the switch unit via the driving terminal thereof, and to adjust a duty cycle of the PWM signal according to a voltage at the power supply terminal.

### BRIEF DESCRIPTION OF THE DRAWINGS

Other features and advantages of the present invention will become apparent in the following detailed description of embodiments with reference to the accompanying drawings, of which:

FIG. 1 is a schematic circuit diagram illustrating a first embodiment of the light emitting device according to the present disclosure;

FIG. 2 is a schematic circuit diagram illustrating a second embodiment of the light emitting device according to the present disclosure; and

FIG. 3 is a schematic circuit diagram illustrating a third embodiment of the light emitting device according to the present disclosure.

### DETAILED DESCRIPTION OF THE EMBODIMENTS

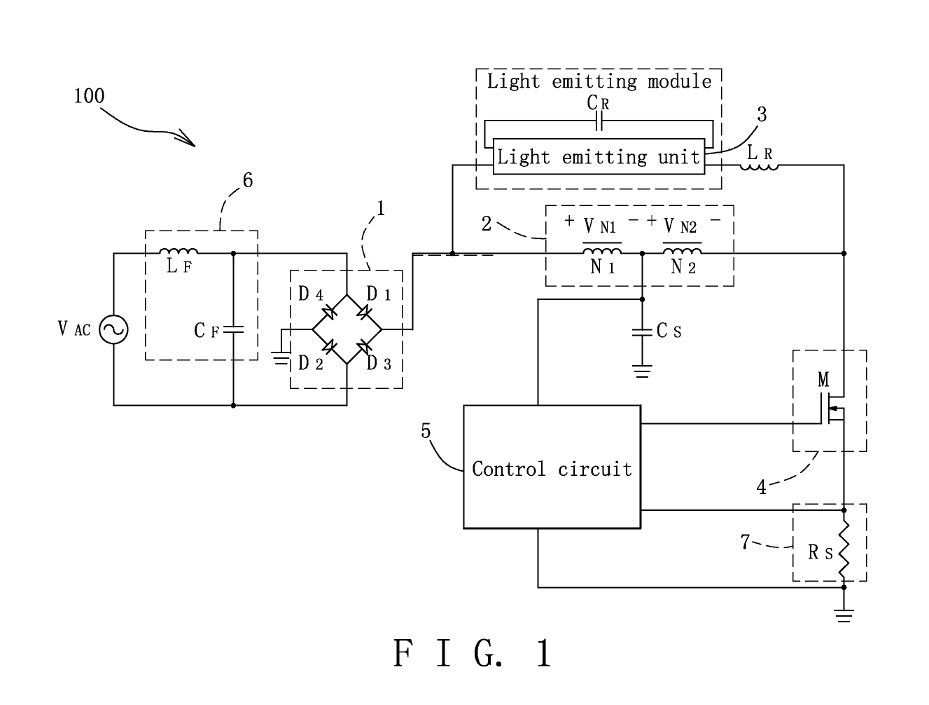

Referring to FIG. 1, the first embodiment of the light emitting device 100 according to this disclosure is shown to receive an alternating-current (AC) voltage signal generated by an AC signal source V_{AC}, and may include a rectifier circuit 1, a mutual inductance device 2 (e.g., a transformer), an energy-storing capacitor C_{S}, a light emitting module that includes a light emitting unit 3 and a resonant capacitor C_{R}, a resonant inductor L_{R}, a switch unit 4, a control circuit 5 (e.g., a processor), a feedback unit 7 and a filter circuit 6.

The AC signal source V_{AC} has a first terminal and a second terminal. The filter circuit 6 is electrically coupled between the rectifier circuit 1 and the AC signal source V_{AC}. The filter circuit 6 receives and filters the AC voltage signal, and provides the filtered AC voltage signal to the rectifier circuit 1. The filter circuit 6 has a first terminal electrically coupled to the first terminal of the AC signal source V_{AC}, a second terminal, and a third terminal electrically coupled to the second terminal of the AC signal source V_{AC}. In this embodiment, the filter circuit 6 includes a filtering inductor L_{F} and a filtering capacitor C_{F}. The filtering inductor L_{F} has a first terminal electrically coupled to the first terminal of the filter circuit 6, and a second terminal electrically coupled to the second terminal of the filter circuit 6. The filtering capacitor C_{F} has a first terminal electrically coupled to the second terminal of the filter circuit 6, and a second terminal electrically coupled to the third terminal of the filter circuit 6.

The rectifier circuit 1 is electrically coupled to the filter circuit 6 for receiving and rectifying the filtered AC voltage signal, and generates a rectified signal. The rectifier circuit 1 has a first terminal electrically coupled to the second terminal of the filter circuit 6, a second terminal electrically coupled to the second terminal of the AC signal source V_{AC}, a third terminal electrically coupled to the mutual inductance device 2 and the light emitting unit 3 for providing the rectified signal thereto, and a grounded fourth terminal. In this embodiment, the rectifier 1 includes a first diode D₁, a second diode D₂, a third diode D₃ and a fourth diode D₄. The first diode D₁ has an anode and a cathode respectively and electrically coupled to the first terminal and the third terminal of the rectifier circuit 1. The second diode D₂ has an anode and a cathode respectively and electrically coupled to the fourth terminal and the second terminal of the rectifier circuit 1. The third diode D₃ has an anode and a cathode respectively and electrically coupled to the second terminal and the third terminal of the rectifier circuit 1. The fourth diode D₄ has an anode and a cathode respectively and electrically coupled to the fourth terminal and the first terminal of the rectifier circuit 1.

The mutual inductance device 2 includes a primary winding N₁ and a secondary winding N₂. The primary winding N₁ has a first terminal electrically coupled to the third terminal of the rectifier circuit 1, and a second terminal. The secondary winding N₂ has a first terminal electrically coupled to the second terminal of the primary winding N₁, and a second terminal. The energy-storing capacitor C_{S} has a first terminal electrically coupled to the second terminal of the primary winding N₁, and a grounded second terminal.

The light emitting unit 3 includes a first terminal electrically coupled to the first terminal of the primary winding N₁, a second terminal, a third terminal and a fourth terminal. In this embodiment, the light emitting unit 3 is driven by a high-frequency AC signal, and may be an AC-type fluorescent lamp (e.g., a fluorescent tube), or a combination of an AC-type gas-discharge lamp (e.g., a high-intensity discharge (HID) lamp) and a high-voltage driving circuit thereof. The resonant capacitor C_{R} has a first terminal electrically coupled to the third terminal of the light emitting unit 3, and a second terminal electrically coupled to the fourth terminal of the light emitting unit 3. In other words, the resonant capacitor C_{R} is electrically coupled across the light emitting unit 3 at the third and fourth terminals of the latter. The resonant inductor L_{R} has a first terminal electrically coupled to the second terminal of the light emitting unit 3, and a second terminal electrically coupled to the second terminal of the secondary winding N₂. Accordingly, a series connection of the resonant inductor L_{R} and the light emitting module is electrically coupled between the first terminal of the primary winding N₁ and the second terminal of the secondary winding N₂.

The switch unit 4 has a first terminal electrically coupled to the second terminal of the secondary winding N₂, a second terminal, and a control terminal receiving a pulse width modulation (PWM) signal, and is configured to make or break electrical connection between the first and second terminals thereof in response to the PWM signal. In this embodiment, the switch unit 4 includes a transistor M that has a drain terminal, a source terminal and a gate terminal respectively and electrically coupled to the first terminal, the second terminal and the control terminal of the switch unit 4.

The feedback unit 7 has a first terminal electrically coupled to the second terminal of the switch unit 4, a second terminal and a grounded third terminal. The feedback unit 7 is configured to sense a voltage or a current at the second terminal of the switch unit 4, and provides a sensed result at the second terminal thereof. In this embodiment, the feedback unit 7 includes a sensing resistor R_{S} that has a first terminal electrically coupled to the first and second terminals of the feedback unit 7, and a second terminal electrically coupled to the third terminal of the feedback unit 7.

The control circuit 5 has a power supply terminal electrically coupled to the energy-storing capacitor C_{S}, a reference terminal to receive a reference voltage, a driving terminal electrically coupled to the control terminal of the switch unit 4, and a sensing terminal electrically coupled to the second terminal of the feedback unit 7 for receiving the sensed result therefrom. In this embodiment, the reference terminal is electrically coupled to the third terminal of the feedback unit 7 (i.e., grounded). The control circuit 5 generates and provides the PWM signal to the control terminal of the switch unit 4 via the driving terminal thereof, to thereby control the switch unit 4 to make or break electrical connection between the first and second terminals thereof, i.e., the control circuit 5 controls the switch unit 4 to conduct or non-conduct.

When the control circuit 5 controls the switch unit 4 to make electrical connection, the secondary winding N₂ generates a voltage V_{N2}, and the primary winding N₁ generates a voltage V_{N1} by induction. A resulting voltage V_{N1}+V_{N2} forms a resonant voltage that drives emission of the light emitting unit 3. Since the resonant voltage V_{N1}+V_{N2} is higher than the AC voltage signal of the AC signal source V_{AC}, the mutual inductance device 2 may not receive the AC voltage signal of the AC signal source V_{AC}. In addition, since the resonant voltage V_{N1}+V_{N2} may be higher than a voltage conventionally used for driving the light emitting unit 3, a time required to start light emission of the light emitting unit 3 may be effectively reduced.

When the control circuit 5 then controls the switch unit 4 to break electrical connection, the light emitting unit 3 is driven by a reversed voltage V_{N1}+V_{N2}, and energy stored by the primary winding N₁ is released to the energy-storing capacitor C_{S} while the energy-storing capacitor C_{S} is charged by the AC signal source V_{AC} at the same time. That is, the energy-storing capacitor C_{S} is charged with a voltage of V_{AC}+V_{N1}. In such a manner, even when the AC voltage signal is lower than a voltage across the energy-storing capacitor C_{S}, charging of the energy-storing capacitor C_{S} may still proceed, so as to synchronize the AC voltage signal with a current that charges the energy-storing capacitor C_{S}, resulting in a high power factor of the light emitting device 100. Moreover, a frequency of a current flowing from the primary winding N₁ to the filter circuit 6 may be lowered to a frequency of the AC signal source V_{AC} and synchronized with the AC voltage signal, which may also lead to a high power factor of the light emitting device 100.

It should be noted that the control circuit 5 may sense the voltage at the second terminal of the switch unit 4 via the second terminal of the feedback unit 7. When the voltage at the second terminal of the switch unit 4 is higher than a pre-designed threshold value, the control circuit 5 controls the switch unit 4 to break electrical connection between the first and second terminals thereof until beginning of the next cycle of the PWM signal. By virtue of cooperation of the control circuit 5 and the sensing resistor R_{S} of the feedback unit 7, a current flowing through the switch unit 4 may thus be controlled, to thereby stabilize the current.

Furthermore, the control circuit 5 may adjust a duty cycle of the PWM signal according to a voltage at the power supply terminal thereof, to thereby stabilize the voltage at the power supply terminal via the voltage feedback mechanism.

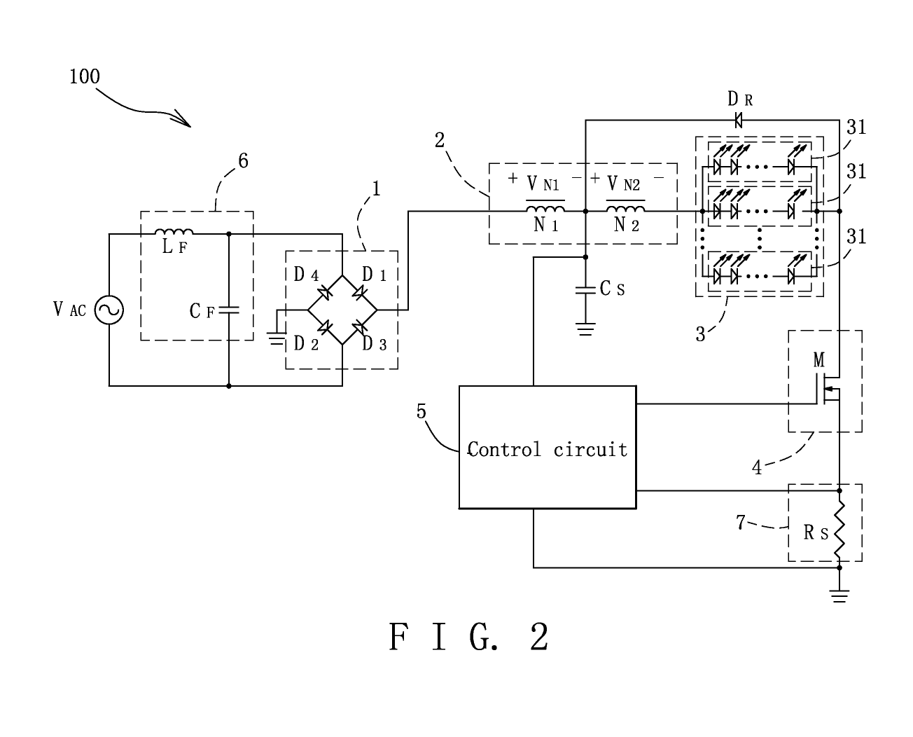

Referring to FIG. 2, the second embodiment of the light emitting device 100 according to this disclosure is shown to be similar to the first embodiment, and primary differences therebetween are described hereinafter.

In this embodiment, the resonant capacitor C_{R} and the resonant inductor L_{R} of the first embodiment are omitted. The light emitting unit 3 may have a first terminal electrically coupled to the second terminal of the secondary winding N₂, and a second terminal electrically coupled to the first terminal of the switch unit 4. The light emitting unit 3 may be driven using a direct-current (DC) voltage, and may be a light emitting diode (LED) unit. The light emitting unit 3 may include a plurality of LED strings 31 that are electrically coupled in parallel between the first and second terminals of the light emitting unit 3. Each of the LED strings 31 includes a plurality of LEDs electrically coupled in series. The light emitting device 100 may further include a rectifying diode D_{R} that has an anode electrically coupled to the second terminal of the light emitting unit 3, and a cathode electrically coupled to the first terminal of the secondary winding N₂.

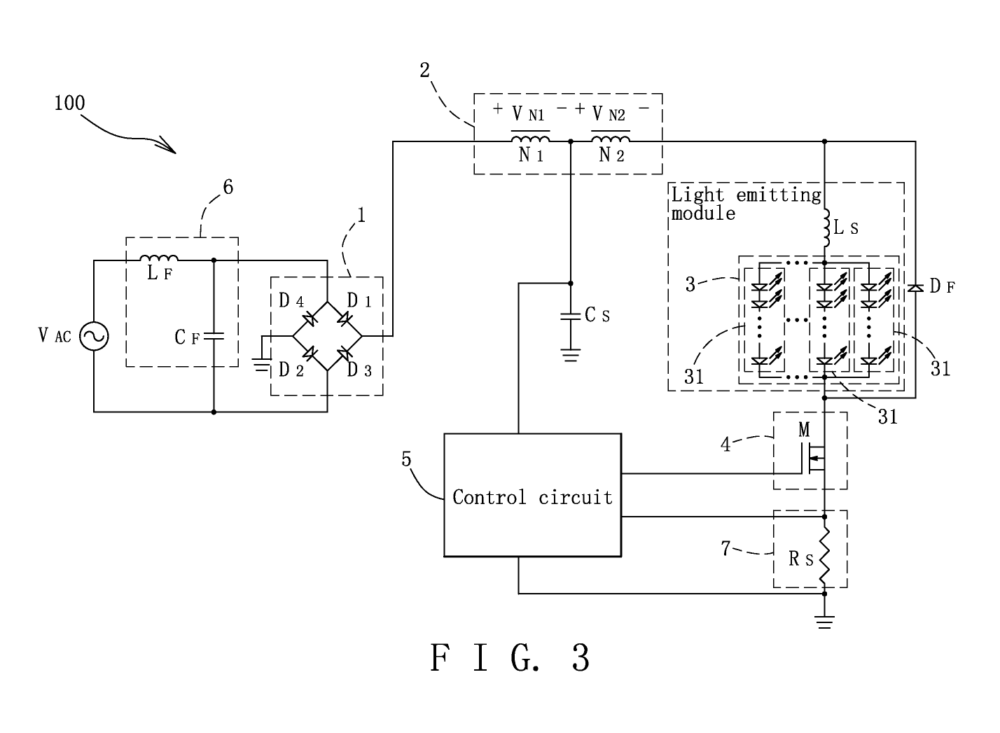

Referring to FIG. 3, the third embodiment of the light emitting device 100 according to this disclosure is shown to be similar to the second embodiment, and primary differences therebetween are described hereinafter.

In this embodiment, the rectifying diode D_{R} of the second embodiment is omitted. The light emitting device 100 may further include an energy-storing inductor L_{S} that cooperates with the light emitting unit 3 to form a light emitting module, and a freewheeling diode D_{F}. The energy-storing inductor L_{S} has a first terminal electrically coupled to the second terminal of the secondary winding N₂, and a second terminal. The first terminal of the light emitting unit 3 is electrically coupled to the second terminal of the energy-storing inductor L_{S}, and the second terminal of the light emitting unit 3 is electrically coupled to the first terminal of the switch unit 4. The freewheeling diode D_{F} has an anode electrically coupled to the second terminal of the light emitting unit 3, and a cathode electrically coupled to the first terminal of the energy-storing inductor L_{S}. Cooperation of the energy-storing inductor L_{S} and the freewheeling diode D_{F} may reduce a ripple of a current flowing through the light emitting unit 3.

In summary, the light emitting device 100 of this disclosure includes the control circuit 5, the switch unit 4, the mutual inductance device 2, the rectifier circuit 1, the filter circuit 6 and the energy-storing capacitor C_{S} that cooperate with each other to synchronize the current that charges the energy-storing capacitor C_{S} with the AC voltage signal, thereby resulting in a high power factor of the light emitting device 100. By virtue of cooperation of the control circuit 5 and the sensing resistor R_{S} of the feedback unit 7, the current that flows through the light emitting unit 3 may be effectively stabilized. In addition, the control circuit 5 adjusts the duty cycle of the PWM signal according to the voltage at the power supply terminal thereof, thereby forming the voltage feedback mechanism that may stabilize the voltage at the power supply terminal.

While the present disclosure has been described in connection with what are considered the most practical embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A light emitting device adapted to receive an alternating-current (AC) voltage signal generated by an AC signal source, said light emitting device comprising:
a rectifier circuit to be electrically coupled to the AC signal source for receiving and rectifying the AC voltage signal, and configured to generate a rectified signal;
a mutual inductance device including:
a primary winding having a first terminal electrically coupled to said rectifier circuit for receiving the rectified signal, and a second terminal; and
a secondary winding having a first terminal electrically coupled to said second terminal of said primary winding, and a second terminal;
an energy-storing capacitor having a first terminal electrically coupled to said second terminal of said primary winding, and a second terminal;
a light emitting module including:
a light emitting unit; and
a resonant capacitor electrically coupled across said light emitting unit;
a resonant inductor in series connection with said light emitting module, said series connection of said resonant inductor and said light emitting module being electrically coupled between said first terminal of said primary winding and said second terminal of said secondary winding;
a switch unit and a feedback unit that are electrically coupled in series, and that are configured to electrically couple said second terminal of said secondary winding to a reference node, wherein said switch unit is disposed to receive a pulse width modulation (PWM) signal, and is configured to make or break electrical connection in response to the PWM signal, said feedback unit being configured to sense one of a voltage and a current associated with a common node of said switch unit and said feedback unit, and to provide a sensed result; and
a control circuit having a power supply terminal electrically coupled to said first terminal of said energy-storing capacitor, a driving terminal electrically coupled to said switch unit, and a sensing terminal electrically coupled to said feedback unit for receiving the sensed result therefrom, said control circuit being configured to generate and provide the PWM signal to said switch unit via said driving terminal thereof, and to adjust a duty cycle of the PWM signal according to a voltage at said power supply terminal.

2. The light emitting device according to claim 1, wherein:
said feedback unit includes a sensing resistor electrically coupled to said switch unit in series, and to electrically couple said switch unit to the reference node; and
when a voltage at the common node of said sensing resistor and said switch unit that is sensed by said feedback unit is higher than a threshold value, said control circuit controls said switch unit to break electrical connection until beginning of a next cycle of the PWM signal.

3. The light emitting device according to claim 1, further comprising a filter circuit disposed to electrically couple said rectifier circuit to the AC signal source, and configured to receive and filter the AC voltage signal, and to provide the AC voltage signal thus filtered to said rectifier circuit.

4. The light emitting device according to claim 3, wherein:
the AC signal source has a first terminal and a second terminal;
said filter circuit has a first terminal to be electrically coupled to the first terminal of the AC signal source, a second terminal, and a third terminal to be electrically coupled to the second terminal of the AC signal source;
said rectifier circuit has a first terminal electrically coupled to said second terminal of said filter circuit, a second terminal to be electrically coupled to the second terminal of the AC signal source, a third terminal electrically coupled to said first terminal of said primary winding, and a fourth terminal to be electrically coupled to a node having a reference voltage.

5. The light emitting device according to claim 4, wherein said filter circuit includes:
a filtering inductor having a first terminal electrically coupled to said first terminal of said filter circuit, and a second terminal electrically coupled to said second terminal of said filter circuit; and
a filtering capacitor having a first terminal electrically coupled to said second terminal of said filter circuit, and a second terminal electrically coupled to said third terminal of said filter circuit.

6. The light emitting device according to claim 4, wherein said rectifier circuit includes:
a first diode having an anode and a cathode respectively and electrically coupled to said first terminal and said third terminal of said rectifier circuit;
a second diode having an anode and a cathode respectively and electrically coupled to said fourth terminal and said second terminal of said rectifier circuit;
a third diode having an anode and a cathode respectively and electrically coupled to said second terminal and said third terminal of said rectifier circuit; and
a fourth diode having an anode and a cathode respectively and electrically coupled to said fourth terminal and said first terminal of said rectifier circuit.

7. The light emitting device according to claim 1, wherein said switch unit includes a transistor having a drain terminal, a source terminal, and a gate terminal that receives the PWM signal.

8. A light emitting device adapted to receive an alternating-current (AC) voltage signal generated by an AC signal source, said light emitting device comprising:
a rectifier circuit to be electrically coupled to the AC signal source for receiving and rectifying the AC voltage signal, and configured to generate a rectified signal;
a mutual inductance device including:
a primary winding having a first terminal electrically coupled to said rectifier circuit for receiving the rectified signal, and a second terminal; and
a secondary winding having a first terminal electrically coupled to said second terminal of said primary winding, and a second terminal;
an energy-storing capacitor having a first terminal electrically coupled to said second terminal of said primary winding, and a second terminal;
a light emitting unit having a first terminal electrically coupled to said second terminal of said secondary winding, and a second terminal;
a rectifying diode having an anode electrically coupled to said second terminal of said light emitting unit, and a cathode electrically coupled to said first terminal of said secondary winding;
a switch unit and a feedback unit that are electrically coupled in series, and that are configured to electrically couple said second terminal of said light emitting unit to a reference node, wherein said switch unit is disposed to receive a pulse width modulation (PWM) signal, and is configured to make or break electrical connection in response to the PWM signal, said feedback unit being configured to sense one of a voltage and a current associated with a common node of said switch unit and said feedback unit, and to provide a sensed result; and
a control circuit having a power supply terminal electrically coupled to said first terminal of said energy-storing capacitor, a driving terminal electrically coupled to said switch unit, and a sensing terminal electrically coupled to said feedback unit for receiving the sensed result therefrom, said control circuit being configured to generate and provide the PWM signal to said switch unit via said driving terminal thereof, and to adjust a duty cycle of the PWM signal according to a voltage at said power supply terminal.

9. The light emitting device according to claim 8, wherein:
said feedback unit includes a sensing resistor electrically coupled to said switch unit in series, and to electrically couple said switch unit to the reference node; and
when a voltage at the common node of said sensing resistor and said switch unit that is sensed by said feedback unit is higher than a threshold value, said control circuit controls said switch unit to break electrical connection until beginning of a next cycle of the PWM signal.

10. The light emitting device according to claim 8, further comprising a filter circuit disposed to electrically couple said rectifier circuit to the AC signal source, and configured to receive and filter the AC voltage signal, and to provide the AC voltage signal thus filtered to said rectifier circuit.

11. The light emitting device according to claim 10, wherein:
the AC signal source has a first terminal and a second terminal;
said filter circuit has a first terminal to be electrically coupled to the first terminal of the AC signal source, a second terminal, and a third terminal to be electrically coupled to the second terminal of the AC signal source;
said rectifier circuit has a first terminal electrically coupled to said second terminal of said filter circuit, a second terminal to be electrically coupled to the second terminal of the AC signal source, a third terminal electrically coupled to said first terminal of said primary winding, and a fourth terminal to be electrically coupled to a node having a reference voltage.

12. The light emitting device according to claim 11, wherein said filter circuit includes:
a filtering inductor having a first terminal electrically coupled to said first terminal of said filter circuit, and a second terminal electrically coupled to said second terminal of said filter circuit; and
a filtering capacitor having a first terminal electrically coupled to said second terminal of said filter circuit, and a second terminal electrically coupled to said third terminal of said filter circuit.

13. The light emitting device according to claim 11, wherein said rectifier circuit includes:
a first diode having an anode and a cathode respectively and electrically coupled to said first terminal and said third terminal of said rectifier circuit;
a second diode having an anode and a cathode respectively and electrically coupled to said fourth terminal and said second terminal of said rectifier circuit;
a third diode having an anode and a cathode respectively and electrically coupled to said second terminal and said third terminal of said rectifier circuit; and
a fourth diode having an anode and a cathode respectively and electrically coupled to said fourth terminal and said first terminal of said rectifier circuit.

14. The light emitting device according to claim 8, wherein said switch unit includes a transistor having a drain terminal, a source terminal, and a gate terminal that receives the PWM signal.

15. The light emitting device according to claim 8, wherein said light emitting unit is a light emitting diode (LED) unit that includes a plurality of LED strings that are electrically coupled in parallel between said first terminal and said second terminal of said light emitting unit.

16. A light emitting device adapted to receive an alternating-current (AC) voltage signal generated by an AC signal source, said light emitting device comprising:
a rectifier circuit to be electrically coupled to the AC signal source for receiving and rectifying the AC voltage signal, and configured to generate a rectified signal;
a mutual inductance device including:
a primary winding having a first terminal electrically coupled to said rectifier circuit for receiving the rectified signal, and a second terminal; and
a secondary winding having a first terminal electrically coupled to said second terminal of said primary winding, and a second terminal;
an energy-storing capacitor having a first terminal electrically coupled to said second terminal of said primary winding, and a second terminal;
a light emitting module having a first terminal electrically coupled to said second terminal of said secondary winding, and a second terminal, and including an energy-storing inductor and a light emitting unit electrically coupled in series between said first terminal and said second terminal of said light emitting module;
a freewheeling diode having an anode electrically coupled to said second terminal of said light emitting module, and a cathode electrically coupled to said first terminal of said light emitting module;
a switch unit and a feedback unit that are electrically coupled in series, and that are configured to electrically couple said second terminal of said light emitting module to a reference node, wherein said switch unit is disposed to receive a pulse width modulation (PWM) signal, and is configured to make or break electrical connection in response to the PWM signal, said feedback unit being configured to sense one of a voltage and a current associated with a common node of said switch unit and said feedback unit, and to provide a sensed result; and
a control circuit having a power supply terminal electrically coupled to said first terminal of said energy-storing capacitor, a driving terminal electrically coupled to said switch unit, and a sensing terminal electrically coupled to said feedback unit for receiving the sensed result therefrom, said control circuit being configured to generate and provide the PWM signal to said switch unit via said driving terminal thereof, and to adjust a duty cycle of the PWM signal according to a voltage at said power supply terminal.

17. The light emitting device according to claim 16, wherein:
said feedback unit includes a sensing resistor electrically coupled to said switch unit in series, and to electrically couple said switch unit to the reference node; and
when a voltage at the common node of said sensing resistor and said switch unit that is sensed by said feedback unit is higher than a threshold value, said control circuit controls said switch unit to break electrical connection until beginning of a next cycle of the PWM signal.

18. The light emitting device according to claim 16, further comprising a filter circuit disposed to electrically couple said rectifier circuit to the AC signal source, and configured to receive and filter the AC voltage signal, and to provide the AC voltage signal thus filtered to said rectifier circuit.

19. The light emitting device according to claim 18, wherein:
the AC signal source has a first terminal and a second terminal;
said filter circuit has a first terminal to be electrically coupled to the first terminal of the AC signal source, a second terminal, and a third terminal to be electrically coupled to the second terminal of the AC signal source;
said rectifier circuit has a first terminal electrically coupled to said second terminal of said filter circuit, a second terminal to be electrically coupled to the second terminal of the AC signal source, a third terminal electrically coupled to said first terminal of said primary winding, and a fourth terminal to be electrically coupled to a node having a reference voltage.

20. The light emitting device according to claim 19, wherein said filter circuit includes:
a filtering inductor having a first terminal electrically coupled to said first terminal of said filter circuit, and a second terminal electrically coupled to said second terminal of said filter circuit; and
a filtering capacitor having a first terminal electrically coupled to said second terminal of said filter circuit, and a second terminal electrically coupled to said third terminal of said filter circuit.

21. The light emitting device according to claim 19, wherein said rectifier circuit includes:
a first diode having an anode and a cathode respectively and electrically coupled to said first terminal and said third terminal of said rectifier circuit;
a second diode having an anode and a cathode respectively and electrically coupled to said fourth terminal and said second terminal of said rectifier circuit;
a third diode having an anode and a cathode respectively and electrically coupled to said second terminal and said third terminal of said rectifier circuit; and
a fourth diode having an anode and a cathode respectively and electrically coupled to said fourth terminal and said first terminal of said rectifier circuit.

22. The light emitting device according to claim 16, wherein said switch unit includes a transistor having a drain terminal, a source terminal, and a gate terminal that receives the PWM signal.

23. The light emitting device according to claim 16, wherein said light emitting unit is a light emitting diode (LED) unit that includes a plurality of LED strings that are electrically coupled in parallel between said first terminal and said second terminal of said light emitting unit.
